(19) United States
(12) Patent Application Publication
(10) Pub. No.: US 2020/0389004 A1
(43) Pub. Date: Dec. 10, 2020

(54) ACCESS FLOOR STRUCTURE WITH GRID-PATTERN SUSPENDED CABLE TRAY SYSTEM

(71) Applicants: Yao-Chung CHEN, New Taipei City (TW); Shih-Jan WANG, Taipei City (TW)

(72) Inventors: Yao-Chung CHEN, New Taipei City (TW); Shih-Jan WANG, Taipei City (TW)

(21) Appl. No.: 16/512,775

(22) Filed: Jul. 16, 2019

(30) Foreign Application Priority Data
Jun. 5, 2019 (TW) 108207168

(51) Int. Cl. H02G 3/38; E04F 15/024

(52) U.S. Cl. CPC H02G 3/285; E04F 15/02458

(57) ABSTRACT

A access-floor-structure with grid-pattern suspended cable tray system includes a plurality of first beams and a plurality of second beams connected above and between a plurality of stands having a certain height, and floor units, connecting cover plates and center plates laid, so as to form a large-area access floor. Included below the access-floor-structure with arid-pattern suspended cable tray system further comprises a plurality of wiring troughs and a plurality of connecting bottom plates. The plurality of wiring troughs is provided below the connecting cover plate and is spaced by a distance from the ground. The plurality of connecting bottom plates are correspondingly provided below the center cover plate, and peripheries of each connecting bottom plate is used in connection with one end of each wiring trough, thereby some pipelines required to be installed are provided, and remaining pipelines are provided on the ground outside the plurality of wiring trough.

### BACKGROUND OF THE INVENTION

### Field of the Invention

The present invention relates access floor structure with grid-pattern suspended cable tray system having a simple structure and effectively utilizing an access floor space for providing pipeline diversion and a simple pipeline configuration.

### Description of the Related Art

In the recent years, for a workplace where computers are extensively used, wire distribution and layout of networks and other pipelines are critical and essential. Because each computer needs to connect to other computers or be powered through a network, interleaving of pipelines gets more complex as the numbers of machines and devices increase. If pipelines are exposed to the exterior, not only the environment becomes unsightly but also mobility of individuals is affected. Network floors, which can be installed in a access manner to reserve space for wire distribution and layout therebelow and having a flexibly determined quantity of floor units adapting to the size of an indoor space, have become a mainstream in the modern information offices, and are even further utilized in households and public places.

In the design of the above access floor, pipelines are usually not diverted or separated as being hidden below the access floor; that is, all pipelines such as electrical lines including power lines, phone lines and network lines as well as signal lines are all mixed together. More particularly, in countries where under-floor air conditioning (UFAD) is common (e.g., the U.S.A. and Canada), even larger pipelines such as condensing pipes, hot water pipes and water return pipes and gas pipes are additionally configured below the access floor. As a result, pipelines below the access floor become even more disordered, causing substantial complications and operation inconvenience in regard to installation, maintenance or removal of these pipelines for construction workers of various pipelines.

### SUMMARY OF THE INVENTION

In view of the above issues, on the basis of many years of experience and constant research and improvement, the Applicant provides the present invention that is distinctly different from a conventional structure of the prior art.

It is a primary object of the present invention to provide a raise floor structure having a simple structure and effectively utilizing a access floor space for providing pipeline diversion and a simple pipeline configuration.

It is another object of the present invention to provide an access floor structure with grid-pattern suspended cable tray system facilitating pipeline layout before construction and fast pipeline maintenance after construction for construction workers.

To achieve of the above objects, an access floor structure with grid-pattern suspended cable tray system of the present invention primary includes a plurality of first beams and a plurality of second beams connected above and between a plurality of stands, each of which has a certain height. A floor unit is laid on a range framed by every four first beams, a connecting cover plate is laid on a range framed by every two opposite first beams and every two opposite second beams, and a center cover plate is laid on a range framed by every four second beams, so as to form an access floor with a large area for various pipelines to be configured below. Included below the access floor structure with grid-pattern suspended cable tray system are a plurality of wiring troughs and a plurality of connecting bottom plates. The plurality of wiring troughs are provided below the connecting cover plate and are spaced from by a distance the around. The plurality of connecting bottom plates are correspondingly provided below the center cover plate, and peripheries of each connecting bottom plate is used in connection with one end of each wiring trough, thereby some pipelines required to be installed are provided in the plurality of wiring trough, whereas remaining pipelines can be configured on the ground outside the plurality of wiring trough.

In implementation, two sides of each wiring trough are provided with a plurality of hooks, and each first beam is provided with a plurality of holes corresponding to hook portions of each wiring trough to be hooked thereon, such that each wiring trough is suspended between two first beams and is spaced by a distance from the ground.

In implementation, each wiring trough is a metal-woven mesh body.

In implementation, the peripheries of the connecting bottom plate are provided with a plurality of bent pieces for connected with one end of each wiring trough in a way of hooking.

In implementation, the connecting bottom plate further includes a plurality of insertion pieces, and the connecting bottom plate is provided with a plurality of horizontal through holes and vertical through holes for the insertion pieces to be inserted therein, so as to form a path for guiding the pipelines when the insertion pieces are inserted in the horizontal through holes or vertical through holes.

To further understand the present invention, specific contents and achieved effects of the present invention are given in preferred embodiments with the accompanying drawings and denotations below.

### BRIEF DESCRIPTION OF THE DRAWINGS

FIG. 1 is a structural schematic diagram of an access floor structure with grid-pattern suspended cable tray system according to an embodiment of the present invention;

FIG. 2 is a schematic diagram of wiring troughs, connecting bottom plates and first beams in an assembled state according to an embodiment of the present invention;

FIG. 3 is a schematic diagram of a state of use below floor units according to an embodiment of the present invention;

FIG. 4 is a schematic diagram of a connecting bottom plate in a state of inserted with insertion pieces according to an embodiment of the present invention; and

FIG. 5 is a schematic diagram of a state of pipeline diversion in wiring troughs and connecting bottom plates according to an embodiment of the present invention.

### DETAILED DESCRIPTION OF THE INVENTION

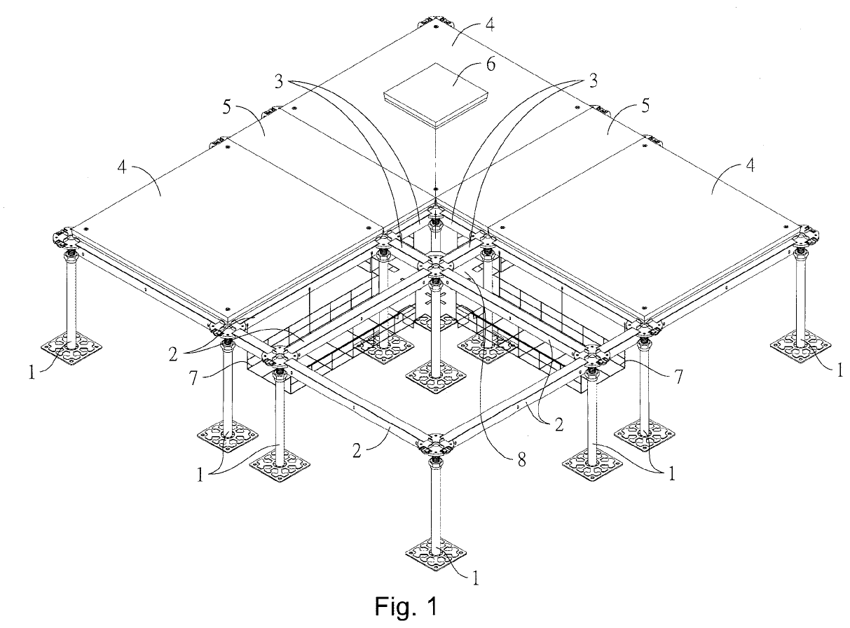

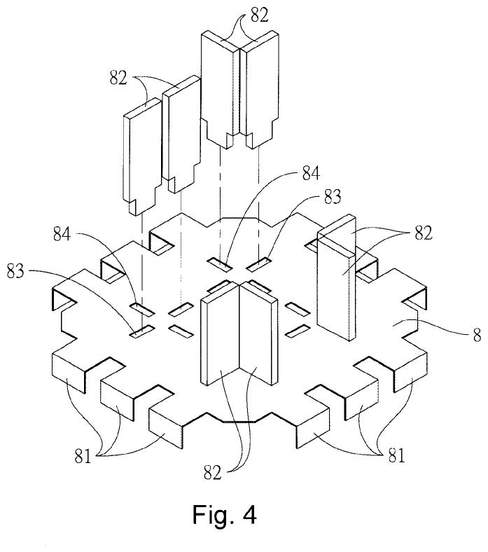

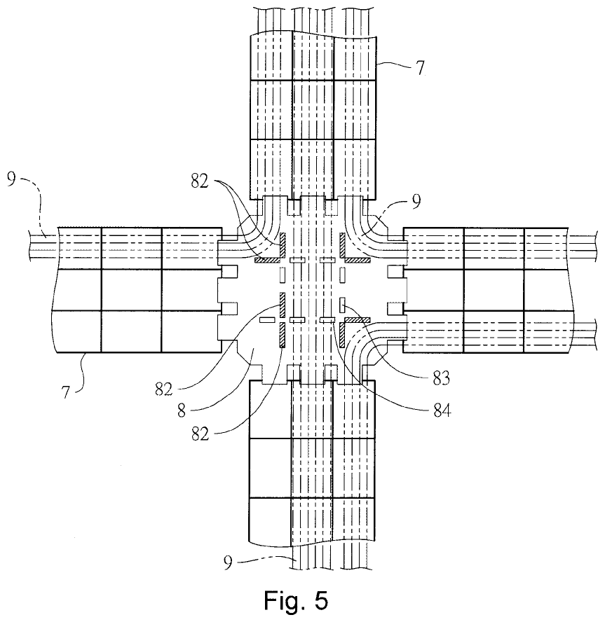

Refer to FIGS. 1 to 5 for an access floor structure with grid-pattern suspended cable tray system according to an embodiment of the present invention.

An access floor structure with grid-pattern suspended cable tray system provided by the present invention primarily includes a plurality of first beams 2 and a plurality of second beams 3 connected above and between a plurality of stands 1 having a certain height. A floor unit 4 is laid on a range framed by every four first beams 1, a connecting cover plate 5 is laid on a range framed by every two opposite first beams 2 and every two opposite second beams 3, and a center cover plate 5 is laid on a range framed by every four second beams 3, thus forming a large-area access floor for various pipelines to be configured below the access floor. Included below the access floor are a plurality of wiring troughs 7 and a plurality of connecting bottom plates 8.

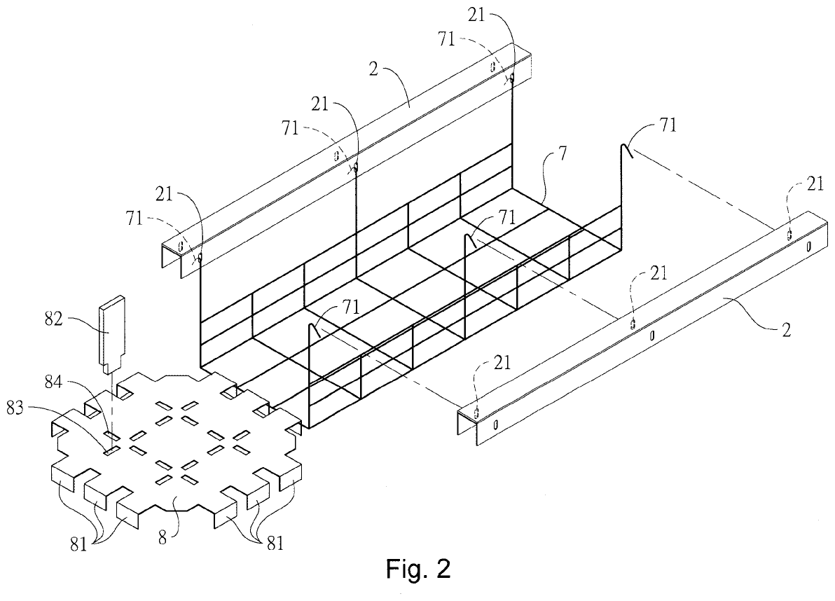

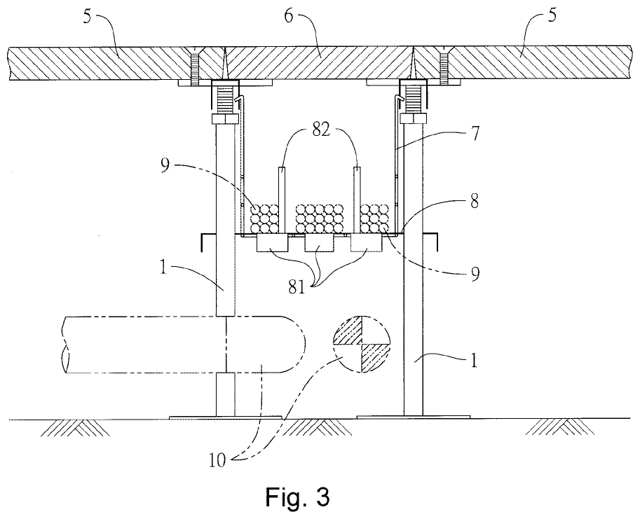

The plurality of wiring troughs 7 are provided below the connecting cover plate 5, and are spaced by a distance from the ground. Each wiring trough 7 is a metal-woven mesh body, and is provided with multiple hook portions 71 on the two sides thereof. The first beam 2 is provided with multiple holes 21 corresponding to the hook portions 71 of each wiring trough 7 to be hooked thereon, such that the plurality of wiring trough 7 is suspended between two first beams 2 and is spaced by a distance from the ground (as shown in FIGS. 2 and 3).

As shown in FIGS. 2 to 4, the plurality of connecting bottom plates 8 are correspondingly provided below the center cover plate 6, and four sides of each connecting bottom plate 8 are for connecting to one end of each wiring trough 7, thus configuring some pipelines 9 needing to be installed in the plurality of wiring trough 7, whereas remaining pipelines 10 can be configured on the ground outside the plurality of wiring trough 7. Four sides of the connecting bottom plate 8 are provided with a plurality of bent pieces for connecting to one end of each wiring trough 7 by means of hooking. The connecting bottom plate 8 further includes a plurality of insertion pieces 82, and the connecting bottom plate 8 is provided with a plurality of horizontal through holes 83 and vertical through holes 84 for the insertion pieces 82 to be inserted therein. Thus, when the insertion pieces 82 are inserted in the horizontal through holes 83 or the vertical through holes 83, a path for guiding the pipelines 9 is formed.

In implementation, when the stands 1, the first beams 2, the second beams 3 and the floor units 4 are completely laid out, each wiring trough 7 can be hooked between two first beams 2, and one end of each wiring trough 7 can be connected using the connecting bottom plate 8 by means of hooking, such that the plurality of wiring trough 7 and the connecting bottom plate 8 form a channel for smaller pipelines 9 such as network lines, power lines and signal lines to be distributed therein, whereas large pipelines 10 such as condensing pipes and hot water pipes needed for under-floor air conditioning (UFAD) are laid on the ground below the floor unit 4. After all the pipelines 9 and 10 are completely installed, the plurality of connecting cover plates 5 and center cover plates 6 can be laid on the plurality of wiring troughs 7 and the connecting bottom plates 8 to form a large-area access floor.

Therefore, the design of the present invention provides the following advantages.

1. The present invention achieves the object of top-bottom diversion of large and small pipelines by using an original space below the access floor by a designs of wiring troughs in a suspended manner. Thus, all pipelines below the access floor are arranged orderly, so as to facilitate inspection and maintenance to reduce working hours and enhancing efficiency when a user later replaces or maintains the pipelines.

Using a design of matching connection between wiring troughs and connecting bottom plates of the present invention, mesh suspension channels are formed below the access floor for small pipelines such as network lines, power lines and signal lines to be securely distributed and configured in the channels. Thus, a construction worker is allowed to perform construction, inspection or maintenance on these pipelines with utter convenience after simply opening the connecting cover plates.

3. In the present invention, horizontal through holes and vertical through holes are additionally provided on the connecting cover plates. With the insertion of the matching insertion pieces, a construction worker is allowed to form a route, e.g., a multi-directional diverting route of a straight line or a bend, for guiding the pipelines on the connecting bottom plates according to wire distribution requirements. Thus, the pipelines on the connecting bottom plates can present better order and clarity, and a construction worker is also facilitated to divert pipelines on the connecting bottom plates.

The above disclosure describes specific embodiments and the implemented technical means of the present invention. Numerous variations and modifications derived and deduced on the basis of the disclosure or teaching of the present application are considered equivalent changes of the concept of the present invention, and the effects generated are within the substantial spirit covered by the description and drawings. Therefore, it should be noted that such variations and modification are to be encompassed within the technical scope of the present invention.

In conclusion, with the access floor structure with grid-pattern suspended cable tray system provided according to the contents of the above disclosure, the present invention achieves the expected results and provides practicability and usability in industry. Therefore, an invention application is filed accordingly.

What is claimed is:

1. An access floor structure with grid-pattern suspended cable tray system, primary comprising a plurality of first beams and a plurality of second beams connected above and between a plurality of stands, each of which has a certain height, a floor unit laid on a range framed by every four first beams, a connecting cover plate laid on a range framed by every two opposite first beams and every two opposite second beams, and a center cover plate laid on a range framed by every four second beams, so as to form an access floor with a large area for various pipelines to be configured below; wherein under the access floor structure with grid-pattern suspended cable tray system further comprising:
a plurality of wiring troughs, provided below the connecting cover plate and spaced by a distance from a ground; and
a plurality of connecting bottom plates, correspondingly provided below the center cover plate, where peripheries of each connecting bottom plates is used in connection with one end of each wiring trough, thereby pipelines required to be installed are provided in the plurality of wiring trough, whereas remaining pipelines are provided on the ground outside the plurality of wiring trough.

2. The access floor structure with grid-pattern suspended cable tray system according to claim 1, wherein two sides of each wiring trough are provided with a plurality of hook portions, and each first beam is provided with a plurality holes corresponding to the hook portions of each wiring trough to be hooked thereon, such that each wiring trough is suspended between two first beams and is spaced by a distance from the ground.

3. The access floor structure with grid-pattern suspended cable tray system according to claim 1, wherein each wiring trough is a metal-woven mesh body.

4. The access floor structure with grid-pattern suspended cable tray system according to claim 1, wherein the peripheries of the connecting bottom plate are provided with a plurality of bent pieces for connected with one end of each wiring trough in a way of hooking.

5. The access floor structure with grid-pattern suspended cable tray system according to claim 1, wherein the connecting bottom plate further comprises a plurality of insertion pieces, and the connecting bottom plate is provided with a plurality of horizontal through holes and vertical through holes for the insertion plates to be inserted therein, so as to form a path for guiding the pipelines when the insertion plates are inserted in the horizontal through holes or the vertical through holes.
